(19) United States
(12) Patent Application Publication
(10) Pub. No.: US 2006/0268838 A1
(43) Pub. Date: Nov. 30, 2006

(54) Authentication of an application layer media flow request for radio resources

(75) Inventors: Anders Larsson, Stockholm (SE); Martin Lars Backstrom, Danderyd (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET LM ERICSSON (publ), Stockholm (SE)

(21) Appl. No.: 11/370,171

(22) Filed: Mar. 8, 2006

Related U.S. Application Data
(60) Provisional application No. 60/684,233, filed on May 25, 2005.

(51) Int. Cl. H04L 12/66; H04L 12/56

(52) U.S. Cl. 370/352; 370/401

(57) ABSTRACT

A radio access bearer authentication procedure prevents a service application running on a mobile station from obtaining a higher level of radio access bearer service than is authorized by the network operator. A secret identifier is determined both at the mobile station and at the radio network. When the mobile's service application requests a particular level of radio access bearer resources, the mobile sends its secret identifier to the radio network which compares the two. Such secret identifiers may be determined from a SIM associated with the mobile. If the secret identifiers match, the radio access network allocates the requested radio access bearer resources for the service application. One example service application is voice over IP (VoIP).

### RELATED CASES

This application claims the benefit and priority of U.S. Provisional Patent Application 60/684,233, filed May 25, 2005, the entire contents of which is incorporated by reference in its entirety.

This application is related to the following related U.S. patent applications:

Ser. No. 10/298,939, filed on Dec. 12, 2005 and entitled “Connection Type Handover Of Voice Over Internet Protocol Call Based On Resource Type,” which is also incorporated by reference in its entirety.

Ser. No. 10/298,938, filed on Dec. 12, 2005 and entitled “Connection Type Handover Of Voice Over Internet Protocol Call Based Low-Quality Detection,” which is also incorporated by reference in its entirety.

Ser. No. 10/314,973, filed on Dec. 22, 2005 and entitled “Local Switching of Calls Setup by a Multimedia Core Network,” which is also incorporated by reference in its entirety.

Ser. No. 10/288,436, filed on Nov. 29, 2005 and entitled “Scheduling Radio Resources For Symmetric Service Data Connections,” which is also incorporated by reference in its entirety.

Ser. No. 10/346,565, filed on Feb. 3, 2006 entitled “Enhanced VoIP Media Flow Quality By Adapting Speech Encoding Based On Selected Modulation And Coding Scheme (MCS),” which is also incorporated by reference in its entirety.

### TECHNICAL FIELD

The present invention pertains to telecommunications and finds advantageous example application to Voice over Internet Protocol (VoIP) communications.

### BACKGROUND

VoIP is the transport of voice traffic using the Internet Protocol (IP). In the mobile world, VoIP means using a packet-switched (PS) service for transport of Internet Protocol (IP) packets which contain, e.g., Adaptive Multi-Rate (AMR) codec speech frames for voice mobile phone calls. A packet-switched connection is often simply referred to as a data connection.

Circuit-switched networks use circuit switching for carrying voice traffic where the network resources are statically allocated from the sender to receiver before the start of the message transfer, thus creating a “circuit.” The resources remain dedicated to the circuit during the entire message transfer and the entire message follows the same path. While this arrangement works quite well to transfer voice, IP is an attractive choice for voice transport for many reasons including lower equipment costs, integration of voice and data applications including multi-media like email, instant messaging, video, the world wide web, etc., lower bandwidth requirements, and the widespread availability of IP.

In packet-switched networks, the message is broken into packets, each of which can take a different route to the destination where the packets are recompiled into the original message. The packet switched (PS) service utilized for VoIP can be, for example, GPRS (General Packet Radio Service), EDGE (Enhanced Data Rates for Global Evolution), or WCDMA (Wideband Code Division Multiple Access). Each of these example services happen to be built upon the Global System for Mobile communications (GSM), a second generation (“2G”) digital radio access technology originally developed for Europe. GSM was enhanced in 2.5G to include technologies such as GPRS. The third generation (3G) comprises mobile telephone technologies covered by the International Telecommunications Union (ITU) IMT-2000 family. The Third Generation Partnership Project (3GPP) is a group of international standards bodies, operators, and vendors working toward standardizing WCDMA-based members of the IMT-2000.

EDGE (sometimes referred to as Enhanced GPRS (EGPRS)) is a 3G technology that delivers broadband-like data speeds to mobile devices. EDGE allows consumers to connect to the Internet and send and receive data, including digital images, web pages and photographs, three times faster than possible with an ordinary GSM/GPRS network. EDGE enables GSM operators to offer higher-speed mobile-data access, serve more mobile-data customers, and free up GSM network capacity to accommodate additional voice traffic. EDGE uses the same TDMA (Time Division Multiple Access) frame structure, logical channels, and 200 kHz carrier bandwidth as GSM networks, which allows existing cell plans to remain intact.

In EDGE technology, a base transceiver station (BTS) communicates with a mobile station (e.g., a cell phone, mobile terminal or the like, including computers such as laptops with mobile termination). The base transceiver station (BTS) typically has plural transceivers (TRX). A time division multiple access (TDMA) radio communication system like GSM, GPRS, and EDGE divides the time space into time slots on a particular radio frequency. Time slots are grouped into frames, with users being assigned one or more time slots. In packet-switched TDMA, even though one user might be assigned one or more time slots, other users may use the same time slot(s). So a time slot scheduler is needed to ensure that the time slots are allocated properly and efficiently.

EDGE offers nine different Modulation and Coding Schemes (MSCs): MCS1 through MCS9. Lower coding schemes (e.g., MCS1-MCS2) deliver a more reliable but slower bit rate and are suitable for less optimal radio conditions. Higher coding schemes (e.g., MCS8-MCS9) deliver a much higher bit rate, but require better radio conditions. Link Quality Control (LQC) selects which MCS to use in each particular situation based on the current radio conditions.

In EDGE, the LQC selects a MCS for radio link control (RLC) data blocks for each temporary block flow (TBF). A TBF is a logical connection between a mobile station (MS) and a packet control unit in the radio access network and is usually located in the base station controller (BSC). A TBF is used for either uplink or downlink transfer of GPRS packet data. The actual packet transfer is made on physical data radio channels (PDCHs). The bit rate for a TBF is thus effectively selected by selecting a MCS, and changing the MCS for a TBF changes its bit rate.

Wireless VoIP requires a certain quality of service (QoS) that is higher than other types of QoS such as basic background QoS provided for regular Internet data traffic. QoS is linked at least in part to bit rate, and thus, to the MCS selected by the LQC entity. Speech requires, for example, fairly low transfer delay and a guaranteed minimum bit rate over the air interface in both the uplink and downlink directions. In order for the radio access network to provide that higher QoS over the air interface, the radio access network must establish a radio access bearer that uses more radio resources than a radio access bearer for regular data Internet traffic that can tolerate delays and fluctuations in bit rate. In short, a VoIP radio access bearer costs the radio access network operator more than a regular data Internet traffic radio access bearer. Normally, that higher cost would be passed on by the network operator to its VoIP subscribers.

But a problem arises if a mobile subscriber's terminal uses a third party VoIP application to “trick” the radio access network into providing the more expensive VoIP radio access bearer service while only paying for cheaper basic Internet data transfer. An example third party VoIP provider is SKYPE. Such a mobile user will be a subscriber with a subscription with a radio network operator for one or more services (which may or may not include VoIP) that permit mobile application programs to request and receive higher quality radio access bearer service by the radio network. Although the radio network initially ensures that the mobile user is an authorized subscriber, the radio access network does not then determine whether that subscriber is an authorized VoIP subscriber. Nor does the network determine whether the subscriber is even using the network's VoIP service (as opposed to a third party's VoIP service) when the mobile is running a VoIP application. Instead, the radio access network is simply focused on configuring radio access bearers to support data flows with the requested QoS for each data flow.

So if an authorized subscriber runs a VoIP application that requests VoIP QoS, the radio access network simply sees that QoS request and configures the radio access bearer to deliver the more expensive QoS, even though the data itself may not be traffic to the operator's own VoIP service (but instead, for example, to a third party server on the Internet). The core network, which is where subscriber billing is normally performed, only sees regular Internet traffic for this data flow. As a result, the core network only charges the user for the lower cost radio access bearer service associated with regular Internet traffic, even though the user is receiving a higher cost radio access bearer service. A related negative consequence is that giving more radio resources and a higher priority to such a mobile user means that other mobile users paying the network operator for VoIP service are de-prioritized and potentially receive lower QoS.

FIG. 1 helps illustrate the problem. The radio communications system 1 includes a mobile radio 2 communicating over a radio interface with a radio access network (RAN) 3. The RAN 3 is coupled to one or more core networks 4, coupled in turn to a mobile network operator's VoIP service node 5 and to a third party VoIP service node 7, e.g., a SKYPE server, via the Internet 6. As shown, the long dashed line represents an authorized VoIP bearer service including radio access bearer (RAB) service at the QoS required to support VoIP. The dotted line represents an unauthorized VoIP bearer service in the sense that a higher quality radio access bearer (RAB) service normally used for delivering VoIP service using the mobile network operator's VoIP service node 5 is being used to support VoIP service sponsored by the third party VoIP service node 7. In essence, the mobile user in the dotted line scenario is getting a “free ride” using the higher quality VoIP RAB service and more expensive LQC without having to pay the higher tariff the network operator would naturally charge for providing that higher level of RAB service normally provided for its own VoIP service.

Access control to a certain quality of service (QoS) profile associated with a mobile subscription is typically not linked to charging for that QoS profile. The mobile sends a QoS request that includes an access point name (APN) to be used. Most network operators have or are moving towards using one on APN for all data services including data services terminated in the operator's service network, such as the mobile network operator's VoIP service node 5 shown in FIG. 1, and data services terminated on the Internet 6. A network node, e.g., an SGSN in EDGE, receives the mobile's request and checks the HLR subscription database that the mobile subscriber subscription profile permits the requested APN and QoS. If permitted, the network node, e.g., the SGSN, signals to the a radio access network control node, e.g., a BSC, to create a packet flow context for the mobile. Based on that packet flow context, the BSC later allocates the requested QoS. As mentioned above, charging is usually done by a core network service node. Charging systems are typically set up to charge for the number of bytes transmitted and the APN used. Charging systems do not consider detailed parameters like QoS.

Given this system arrangement, it is possible to obtain more expensive bearer service and not be charged for it. Consider a third party mobile application program, like a VoIP application program, running on the mobile. That third party mobile application program requests a high quality of radio access bearer service directly from the access network. Instead of sending the application data to the network operator's application server, the third party mobile application program sends the application data to a third party server over the Internet. For a VoIP application, third party VoIP programs might send the VoIP data to a SKYPE server or an MSN server. Consequently, the mobile subscriber is not charged for the more expensive high quality radio access bearer service it receives because the mobile did not use the operator's application server. The core network only charges for the lower quality radio access bearer service associated with delivering the application data packets to the Internet at a lower basic data traffic transport charge.

### SUMMARY

The inventors conceived of a technological solution that overcomes these problems. After a mobile radio has attached to and been authenticated by the mobile radio communications network as a valid mobile subscriber, the radio access network receives a radio resource request associated with the mobile radio for a first level of radio access bearer service. The radio access network receives a secret identifier from the mobile radio in connection with the radio resource request and determines whether the secret identifier is valid. If it is valid, the radio access network allocates the radio resources requested to permit the first level of radio access bearer service to be established. If the secret identifier is invalid, the radio access network either rejects the request, allocates radio resources for a second lower level of radio access bearer service, or takes some other action.

The radio access network preferably (though not necessarily) determines an application layer service associated with the radio resource request. In addition, the radio access network may also make a general determination, not associated with any particular application layer service, whether the mobile subscriber is permitted to receive the first level of radio access bearer service for any application layer service. If not, the subscriber is authorized to only receive the second level of radio access bearer service, e.g., general Internet service. One example of an application layer service is a Voice-over-IP (VoIP) service. In one example embodiment, the first level radio access bearer provides sufficient radio resources to support the VoIP service, and the second level radio access bearer provides sufficient radio resources to support basic data packet transfer over the Internet.

Advantageously, the secret identifier validation procedure ensures that the mobile radio's VoIP service application uses a VoIP service provided by the mobile radio network along with the first level radio access bearer service. The secret identifier validation also prevents the mobile radio's VoIP application from obtaining the first level of radio access bearer service for use with another third party VoIP service provided by an entity other than the mobile radio network operator. A first tariff is initiated for the mobile radio subscriber when the first level radio access bearer service is allocated. A second lower tariff is initiated when the second level radio access bearer services is allocated.

In one non-limiting implementation, the mobile radio sends a VoIP indication message to the radio network, and the secret information is a mobile station (MS) signature derivable from information associated with the mobile radio and information associated with the VoIP indication message. For example, the MS signature is derivable from data associated with subscriber identity module (SIM) data corresponding to the mobile radio subscriber and a frame or sequence number associated with the VoIP indication message. Optionally, a one-way hash function may be used to determine the MS signature with information derivable from authentication triplet data used during general mobile station authentication and the frame or sequence number. In an example application to a GPRS/EDGE network, the VoIP indication message is received from the mobile radio during a temporary block flow (TBF) setup procedure.

### BRIEF DESCRIPTION OF THE DRAWINGS

FIG. 1 is a simplified function block diagram of an example mobile radio communications system showing an example of a mobile obtaining higher quality radio access bearer service but not having to pay for it;

FIG. 2 is a flow chart that outlines non-limiting example procedures for authenticating a mobile requesting a particular level of radio access bearer service to ensure that the subscriber is a valid subscriber and is charged for the level of radio access bearer service used;

FIG. 3 is a function block diagram of an example, non-limiting radio communications system that supports EDGE (Enhanced Data Rates for Global Evolution);

FIG. 4 is a communications protocol diagram of an EDGE (Enhanced Data Rates for Global Evolution) system;

FIG. 5 is a function block diagram of mobile station;

FIG. 6 is a function block diagram of a RAN node;

FIG. 7 is a flow chart diagram that outlines non-limiting example procedures for authenticating a mobile station requesting a particular level of radio access bearer service to ensure that the subscriber is a valid subscriber and is charged for the level of radio access bearer service use; and

FIG. 8 is a diagram illustrating non-limiting example signaling between various GPRS/EDGE nodes.

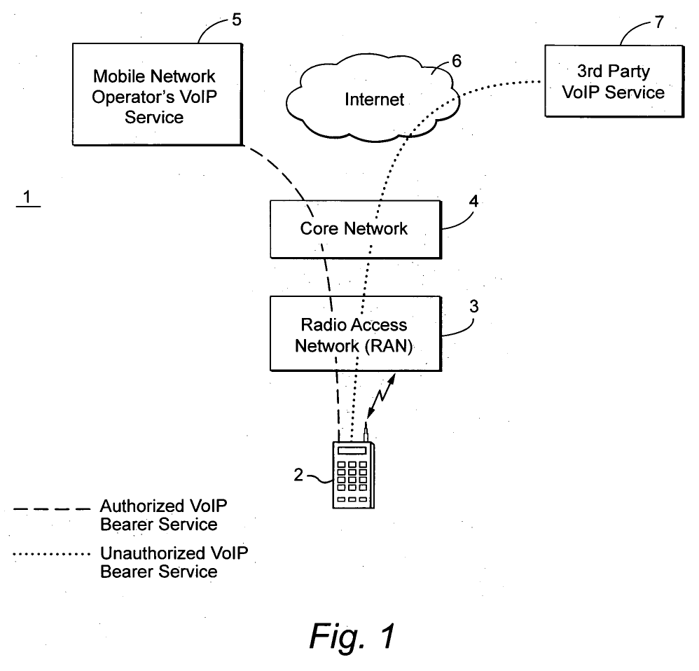

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

The functions of the various elements including functional blocks labeled as “processors” or “controllers” may be provided through the use of dedicated hardware as well as hardware capable of executing software in association with appropriate software. When provided by a processor, the functions may be provided by a single dedicated processor, by a single shared processor, or by a plurality of individual processors, some of which may be shared or distributed. Moreover, explicit use of the term “processor” or “controller” should not be construed to refer exclusively to hardware capable of executing software, and may include, without limitation, digital signal processor (DSP) hardware, read only memory (ROM) for storing software, random access memory (RAM), and non-volatile storage.

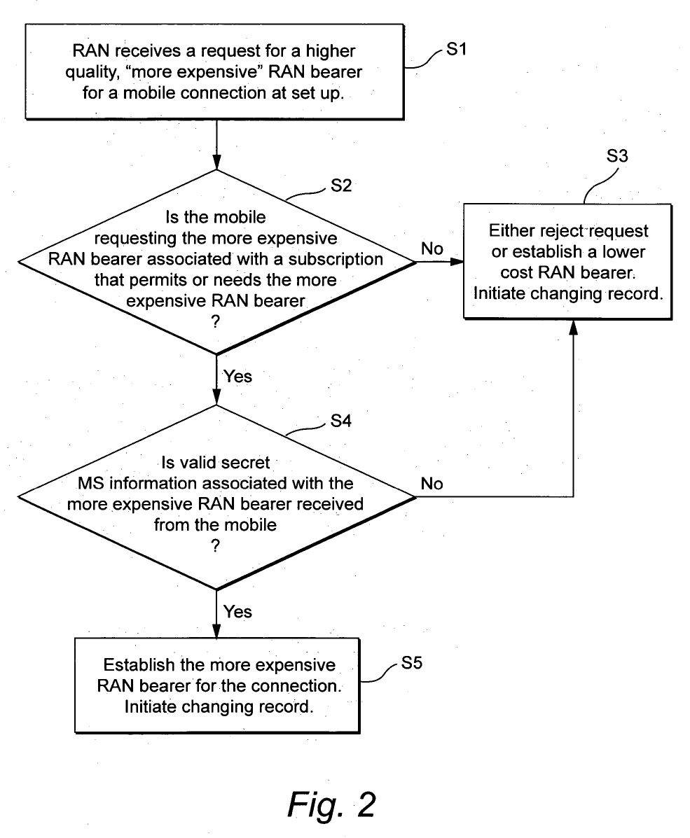

FIG. 2 is a flow chart that outlines non-limiting examples procedures for the radio access network (RAN) to authenticate a mobile station requesting a particular level of radio access bearer (RAB) service to ensure that the mobile subscriber is authorized to receive that level of RAB service and is properly charged for the level of radio access bearer service actually used. Initially, the radio access network (RAN) receives a request for a higher quality, “more expensive” RAN bearer for a mobile connection at connection setup (step S1). An optional decision may be made whether the mobile station requesting the more expensive RAN bearer is associated with a subscription that permits (step S2). If not, the request is either rejected or a lower cost RAN bearer is established (step S3). A charging record associated with the lower cost RAN bearer is initiated to an appropriate charging entity. On the other hand, if the requesting mobile station has an appropriate subscription, a decision is made in step S4 whether valid, secret mobile station information associated with the more expensive RAN bearer has been received from the mobile station. If not, the procedures in step S3 are performed. If so, the more expensive (higher quality) RAN bearer is established for the connection/session, and an appropriate charging record is initiated (step S5). In this way, the radio access network can securely (1) determine whether the mobile station is authorized to receive the more expensive bearer service, and (2) ensure that the more expensive bearer service is charged for when the mobile radio uses it.

Preferably, the secret MS information is information that can only be determined by an application running at the mobile station that has access to secret information. Typically, the secret MS information stored on a secure physical or logical subscription identity module or storage space (referred to in this application as a SIM). The SIM is owned by the network operator that controls (e.g., with security features) what functions have access to the SIM. Third party application software usually do not have access to SIM information. In the example described in the background, the application would be a Voice over IP (VoIP) application. Only a VoIP application in the mobile station provided by the network operator will have access to the SIM or will otherwise have or be able to determine secret mobile station information.

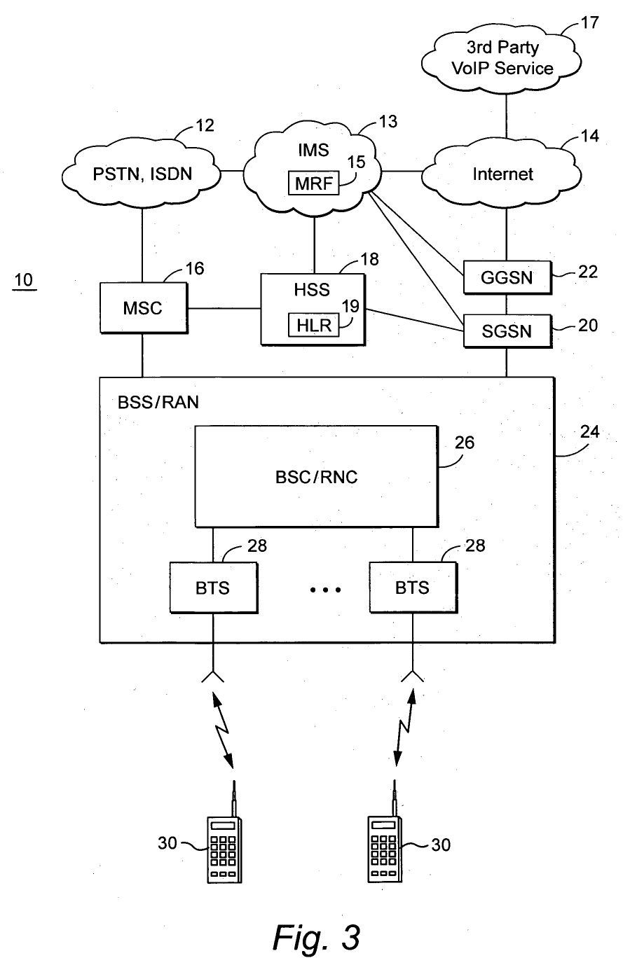

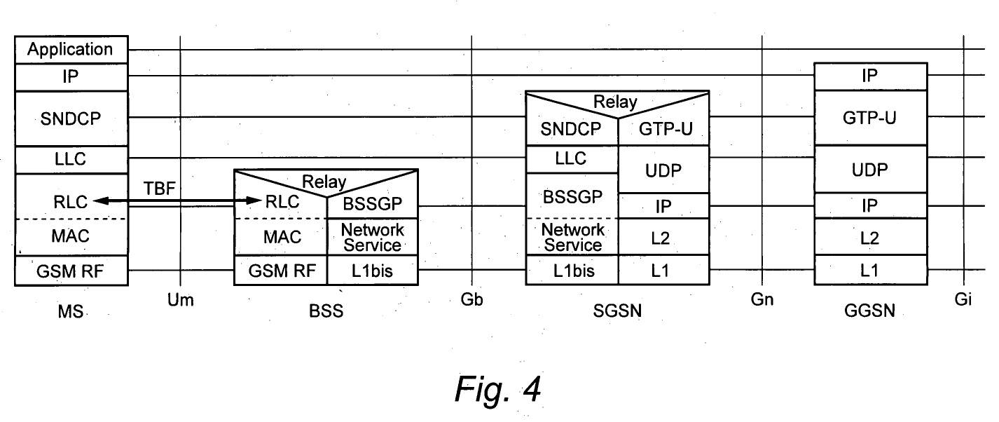

FIG. 3 shows an example mobile radio communications system 10 that couples to one or more circuit-switched networks 12 like the Public Switched Telephone Network (PSTN) and/or the Integrated Services Digital Network (ISDN), etc. via a mobile switching center (MSC) 16 core network node and to one or more packet-switched networks 14 like the Internet via a serving GPRS support node (SGSN) 20 and a gateway GPRS support node (GGSN) 22. The PSTN 12 and ISDN 14 are circuit-switched core networks and the MSC core network node 16 supports circuit-switched services. The Internet 14 is a packet-switched core network, and the SGSN 20 and GGSN 22 are packet-switched core network nodes. In addition to these core networks and associated core network nodes is an Internet Protocol Multimedia Subsystem (IMS) 13 which provides IP-based services, like VoIP, and multimedia services. The IMS 13 may include a media resource function (MRF) 15 to deliver media based services on behalf of the network operator. The IMS is coupled to the core networks, to the GGSN 22, and the SGSN 20. The MSC 16, the IMS 13, and the SGSN 20 are coupled to a mobile subscriber database like a home subscriber server (HSS) 18 that includes a mobile subscriber subscription database HLR 19 and to a radio access network. Attached to the Internet is a third party VoIP service provider (e.g., a SKYPE server) that is not associated with the VoIP service provided by the network operator via the IMS 13.

In a non-limiting example, the radio access network (RAN) is GSM/EDGE based and is referred to as a base station system (BSS) 24 (or it can be simply a RAN). The BSS 24 includes one or more base station controllers (BSCs) 26 (only one is illustrated) coupled to plural base transceiver stations (BTSs) 28. In UMTS, a similar node is called a radio access network controller (RNC). The base station controller 26 controls radio resources and radio connectivity for the cells served by the base transceiver stations BTSs 28 under its control. The BTSs 28 communicate with mobile radio stations (MSs) 30 using radio communication over an air interface. Each BTS 28 serves one or more cells. For each served cell, the base transceiver station 28 provides a pool of radio transmission resources (typically managed and allocated by the BSC) for communicating with mobile stations in that cell. Each base station (BTS) 28 includes a controller as well as radio transceivers and baseband processing circuitry to handle the radio transmission and reception within each served cell.

Each mobile station (MS) 30 includes a radio transceiver and data processing and control entities/functionalities for providing Voice over Internet Protocol (VoIP) capability. The person skilled in the art will recognize that the mobile station 30 and its data processing and control typically include numerous other functionalities and applications in addition to or other than VoIP. The mobile station 30 includes input/output devices such as a display screen, a keypad, a speaker, a microphone, and the like. The mobile station 30 also includes SIM. In one example, the SIM may be a logical application running on a smartcard and includes various mobile subscriber subscription information, preferences, identifiers, and authentication information. Other similar types of modules may be employed such as a universal subscriber identity module (USIM).

In EDGE, EGPRS, or GPRS, a first link layer protocol context, called a temporary block flow (TBF), is set up uplink from the mobile to the radio network, and a second TBF is set up downlink from the radio network to the mobile radio. A TBF can be viewed as a logical connection between a mobile station (MS) and a packet control unit (PCU) in the network, e.g., the BSS. FIG. 3 is a communications protocol diagram of an EDGE system familiar to those skilled in the art. The TBF is shown as a temporary connection between the radio link control (RLC) protocol layer entities in the BSC and the MS. Once an uplink TBF and a downlink TBF have been established for a data connection, then radio resources (time slots in the EDGE type systems) can be assigned to support the connection over the radio/air interface. Base station controller (BSC) 26 relays the LLC frames (depicted as “Relay” on BSS in FIG. 2) between the mobile station (MS) 30 and the core network. The media access control (MAC) layer manages the multiplexing of data blocks arising from various TBFs which are active the available physical radio channel, arbitrating among the various mobile users via a time slot scheduling mechanism orchestrated in the BSC where a TBF is selected for each time slot.

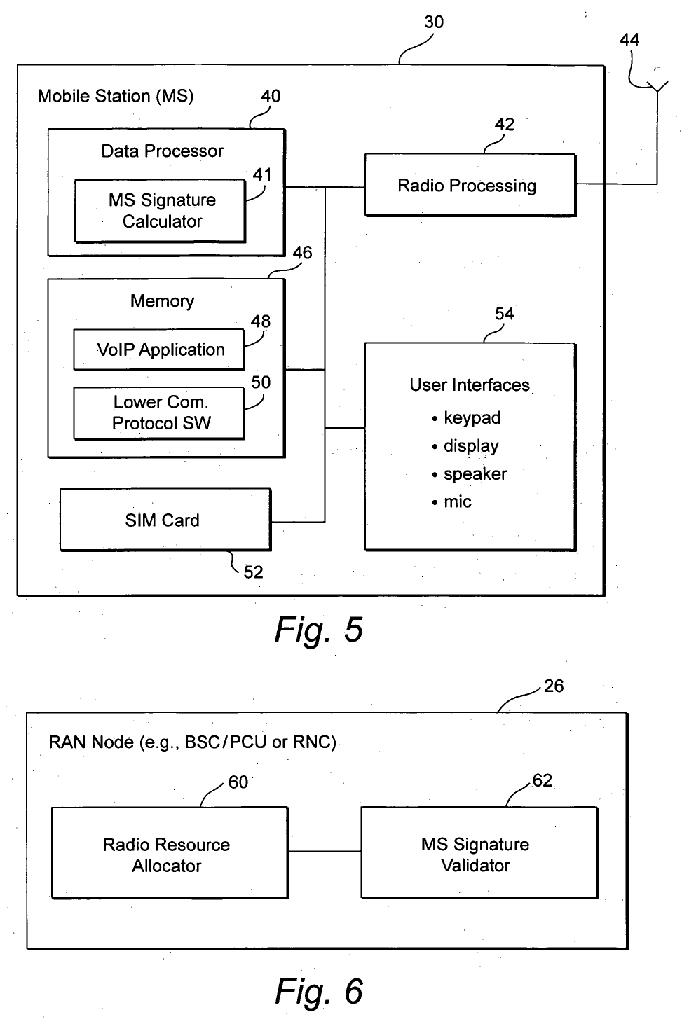

FIG. 5 is a simplified function block diagram of a mobile station (MS) 30. A data processor 40 is coupled to read baseband and radio processing circuitry 42 coupled to an antenna 44. The data processor is also coupled to a memory 46 that includes a VoIP application 48, lower communication protocol software 50 for performing data packet communications, a SIM 52, and various user interfaces 54 including, for example, a keypad, display, speaker, and microphone. SIM cards are well-known in GSM networks. Existing GSM algorithms are employed to authenticate the mobile phone using the SIM card with the mobile switching center (MSC) 16.

The general authentication of a mobile subscriber requesting registration with or attachment to the radio network runs according to an authentication algorithm between the SIM in the mobile phone and the MSC and/or SGSN in a GSM network. Specifically, upon reception of a registration request from the mobile station that includes the mobile's international mobile subscriber identity (IMSI) fetched from the mobile's SIM card, the MSC and/or SGSN requests a profile of the mobile user from the MSC. The MSC and/or SGSN retrieves that profile from the HLR. The profile includes what are known as “authentication triplets.” These authentication triplets consist of a random challenge (RAND), an encrypted version of this challenge (SRES), and a session key (Kc). To generally authenticate a newly-attached mobile station, the MSC and/or SGSN issues the RAND to the mobile station which provides the RAND to its SIM. The SIM returns a “signed” response (SRES) using a private key of a mobile subscriber. The mobile's authentication reply is checked by the MSC and/or SGSN to see if the SRES equals the SRES included in the associated authentication triplet used. If so, the MSC and/or SGSN generally authorizes the mobile subscriber to receive its subscribed services.

In addition to the general mobile subscriber authentication, mobile station secret information associated with a particular application layer service offered by the network operator is used to safeguard radio access bearer resources from being misappropriated for third party service applications. The secret MS information can be any information that is known or derivable only by a network operator authorized entity. As one example, the secret MS information may be determined using one or more pieces of information in from the initial general authentication procedure, e.g., information from or derived from one or more of the authentication triplets in the SIM. The SIM information is non-accessible by third party application layer software. On the other hand, the network operator's service application does have access to the SIM information. If the service application is the network's VoIP service, the operator's VoIP application software in the mobile terminal will be able to access the secret information in the SIM. On the other hand, a SKYPE application on the mobile will not.

In this regard, a mobile station “signature” calculator 41 is provided in the mobile station to calculate a MS secret signature. In the RAN node, such as the BSC or packet control unit (PCU) in an EDGE system (or an RNC in a UMTS system), as shown in FIG. 6, the MS signature is also calculated in the MS signature validator block 62. The mobile station signature can be determined as a function of a SIM secret that is derivable from the SIM specific data to avoid duplication of someone else's signature. Optionally, a frame or sequence number may also be part of the function in order to avoid replay of a previous signature which could have been created by just guessing until successful, and thereafter, reusing that guessed signature forever. Accordingly, the VoIP signature may be calculated as:
VoIP signature=f(SIM_secret, SN or FN) (1)

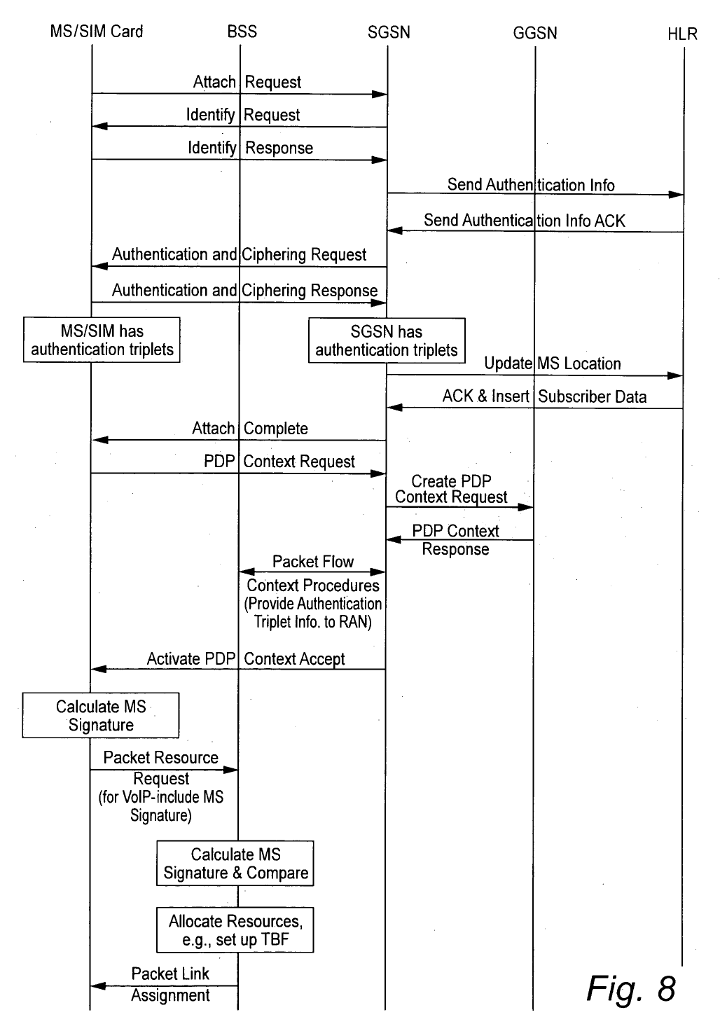

In one non-limiting example implementation, the function “f” can be a secure, one-way hash function such as MD5. The SIM secret can be derived from the mobile's authentication triplets stored in the SIM and from the frame or sequence number when the VoIP request indication message was sent. As will be explained in the example signaling diagram illustrated in FIG. 8 below, the SIM secret information may be provisioned from the SGSN when subscriber profile information is downloaded from the HLR database. Thus, both the mobile station signature calculator 41 and the mobile station signature validator 62 in the radio network node 26 can derive or otherwise calculate the VoIP signature. Third party application software running on a mobile can not legitimately access the secret information in the SIM, and thus, a legitimate VoIP signature cannot be determined. The mobile station can then send the VoIP signature to the RAN node 26 which checks to make sure that it matches the VoIP signature the RAN node 26 has calculated. The resource allocator 60 in the RAN node 26 allocates the appropriate radio access bearer resources based on the result of the matching process. If matching is successful, the resource allocator 60 grants the requested resources. If not, the resource allocator 60 may reject the request, or alternatively, may grant less expensive resources.

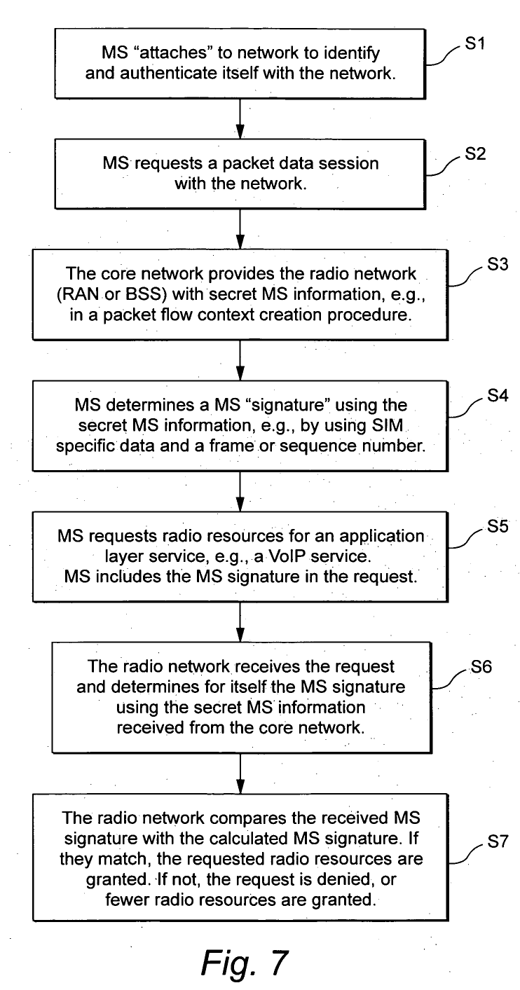

Reference is now made to the flow chart diagram illustrated in FIG. 7 which shows example procedures starting from when the mobile station “attaches” to a radio network. Starting in step S1, the mobile station attaches to the radio network to generally identify, register, and authenticate itself with a radio network. During this process, certain secret information is passed between the mobile station and the network. The mobile station later requests a packet data “session” with the radio network (step S2), e.g., a VoIP session, a web surfing session, an email session, etc. The core network (either the MSC or SGSN depending on the method the mobile uses to attach to the network) provides the radio network with secret mobile station (MS) information (step S3). In one non-limiting example, this information can be provided in a packet flow context creation procedure, as described in more detail in conjunction with FIG. 8. The mobile station determines an MS signature using the secret MS information (step S4). As explained above, the MS signature may be calculated using SIM-specific data for that mobile and a frame or sequence number associated with the mobile station packet session request issued in step S2. The mobile station application requests radio resources for packet data flow for an application layer service, e.g., a VoIP service. In that request, the mobile station includes the MS signature (step S5). After receiving the request for radio resources, the radio network signature validator 62 determines—independently of the received message—the MS signature using the secret MS information it received from the core network MSC in step S3 (step S6). The radio network signature validator 62 compares the received MS signature with the calculated MS signature. If they match, the resource allocator 60 grants requested radio resources. If not, the request is denied, or fewer radio resources are granted (step S7).

FIG. 8 is a non-limiting example signaling diagram that may be used in a GPRS/EDGE type network. Other appropriate signaling messages could be used in other type networks. The mobile station initiates an “attach” procedure by transmitting an Attach Request message that provides among other things its IMSI (or other suitable identifier) to the SGSN. If the mobile is unknown in the SGSN, the SGSN sends an Identity Request message to the mobile station, and the mobile station responds with an Identity Response message including its IMSI. General mobile subscriber authentication procedures are then performed between the mobile station and the SGSN resulting in authentication triplets from the HLR being stored in the SGSN. First, the SGSN sends an Authentication Info (IMSI) message to the HLR. The HLR responds with a Send Authentication Info Ack (Authentication Triplets) message. The SGSN sends an Authentication and Ciphering Request (RAND, . . . ) message to the MS. The MS responds with an Authentication and Ciphering Response (SRES) message. As explained above, the authentication triplets include a RAND, a SRES, and a Kc. Further information about general authentication procedures may be found in 3GPP TS 23.060. As indicated in FIG. 8, the SGSN now has authentication triplets for this mobile station that correspond to the triplets stored in the mobile station's SIM.

After authentication, the SGSN updates the mobile station's location in the HLR database. The HLR sends an acknowledgement (ACK) as well as in search of subscriber data including the mobile's IMSI and subscription data. The SGSN then sends an Attach Complete message to the mobile station.

When a mobile station wants to start a VoIP session, it sends an Activate PDP Context Request message to the SGSN. The SGSN sends a Create PDP Context Request message to the appropriate GGSN which functions as the access point node (APN) for this session. The GGSN creates a new entry in its PDP context table and generates a charging ID. This new entry allows the GGSN to route packet data units between the GGSN and the packet data network and to start charging. The GGSN then returns a Create PDP Context Response message including the PDP address, configuration options, charging ID, and negotiated quality of service (QoS) to the SGSN.

At this point in an EDGE type network, BSS packet flow context procedures are executed. Such procedures are assumed for this signaling diagram. Alternatively, in a UMTS type network, radio access bearer assignment procedures would be performed at this point. Example BSS packet flow context creation procedures are described in 3GPP TS 23.060. As part of the BSS packet flow context creation procedure, the authentication triplets (or other suitable secret information) may be added to the Create BSS Packet Flow Context Request message sent from the SGSN to the BSS. Alternatively, a subset of the authentication triplets, e.g., only the random challenge (RAND), the session key (Kc) or even on a few digits from the expected sign response (SRAND) may be provided in that message in order to avoid spreading the full authentication triplets in the system. In any event, the BSC will then have mobile station secret information that the mobile station has in its SIM card. Thereafter, an Activate PDP Context Accept message is sent from the SGSN to the MS.

The mobile station calculates an MS signature using the SIM-specific data to avoid duplication of somebody else's signature. The mobile optionally may determine a frame number of the radio block where the message will sent to avoid replay of a previous signature which could have been created by successful guessing and then reused forever. Alternatively, a sequence number increased by a predetermined amount at each request could be used. One example way to calculate the MS signature is using equation (1) above.

After calculating the MS signature, the VoIP application in the mobile station will send a Packet Resource Request message (as part of the BSS packet flow context creation) to the BSC for VoIP-over-EDGE and a temporary block flow (TBF) will be established. Included in this request is the MS signature. The BSC calculates the MS signature and compares it with the MS signature provided by the mobile station in the packet resource request message. If it matches, the necessary radio resources to support the VoIP over EDGE service are allocated in the TBF. A Packet Link Assignment message is then sent from the BSC to the mobile station. Of course, if the MS signatures do not match, the packet resource request can be rejected or some lower quality/amount of resources could be allocated, if desired.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. It is to be understood that the invention is not to be limited to the disclosed embodiment, but on the contrary, is intended to cover various modifications and equivalent arrangements.

What is claimed is:

1. A method for use in a mobile communications network and implemented in the mobile communications network, the method comprising the steps of:
after a mobile radio has been attached and authenticated by the radio communications network as a valid subscriber of the radio communications network, receiving a radio resource request associated with an application layer service and with the mobile radio, where the radio resource request is for a first level of radio access bearer service;
receiving a secret identifier from the mobile radio in connection with the radio resource request;
determining whether the secret identifier is valid; and
if the secret identifier is valid, allocating the radio resources requested to permit the first level of radio access bearer service to be established for the associated application layer service.

2. The method in claim 1, further comprising:
if the secret identifier is invalid, allocating radio resources to permit a second level of radio access bearer service to be established,
wherein the first level is allocated more radio resources than the second level.

3. The method in claim 2, further comprising:
determining if the subscriber is generally permitted to receive the first level of radio access bearer service, and
if not, authorizing the subscriber to receive only the second level of radio access bearer service.

4. The method in claim 2, wherein the application layer service is a Voice over IP (VoIP) service application.

5. The method in claim 4, wherein the first level radio access bearer provides sufficient radio resources to support the VoIP service and the second level radio access bearer provides sufficient radio resources to support basic data packet transfer over the Internet.

6. The method in claim 4, wherein the mobile radio is associated with a subscription with the mobile radio network that permits the first level of radio access bearer service, and
wherein the secret identifier validating step ensures that the mobile radio's VoIP service application uses a VoIP service provided by the mobile radio network with the first level of radio access bearer service and prevents the VoIP application from obtaining the first level of radio access bearer service for use with another VoIP service provided by an entity other than the mobile radio network.

7. The method in claim 4, further comprising:
initiating a first tariff for the mobile radio subscriber when the first level radio access bearer service is allocated for the VoIP service, and
initiating a second lower tariff for the mobile radio subscriber when the second level radio access bearer service is allocated.

8. The method in claim 4, wherein a VoIP indication message is received from the mobile radio, and the secret information is a signature derivable from information associated with the mobile radio and information associated with the VoIP indication message.

9. The method in claim 8, wherein the signature is derivable from data associated with subscriber identity module (SIM) data corresponding to the mobile radio.

10. The method in claim 9, wherein the signature is derivable from data associated with a frame number or a sequence number associated with the VoIP indication message.

11. The method in claim 9, wherein the radio communications network is an EDGE type network, and
wherein the VoIP indication message is received from the mobile radio during a temporary block flow (TBF) set up procedure.

12. The method in claim 11, wherein the SIM data includes authentication triplets, and
wherein the signature is a one-way hash function that uses information derivable from authentication triplet data used during the mobile station authentication and the frame or sequence number.

13. A method implemented by a mobile radio for use in communicating with a mobile communications network, the method comprising the steps of:
attaching to and authenticating with the radio communications network;
executing an application associated with an application layer service;
sending a radio resource request the radio communications network for a first level of radio access bearer service to support the application layer service;
sending to the radio communications network a secret identifier in connection with the radio resource request; and
if the secret identifier is determined to be valid, receiving a message from the radio communications network that the radio resources requested are allocated; and
continuing execution of the application using the first level of radio access bearer service.

14. The method in claim 13, further comprising:
if the secret identifier is determined to be invalid, receiving a message from the radio communications network that the radio resources requested will not be allocated; and
continuing execution of the application using the second level of radio access bearer service.

15. The method in claim 14, wherein the application is a Voice over IP (VoIP) service application.

16. The method in claim 15, wherein the first level radio access bearer provides sufficient radio resources to support the VoIP service and the second level radio access bearer provides sufficient radio resources to support basic data packet transfer over the Internet.

17. The method in claim 15, wherein the secret identifier is a signature, the method further comprising:
determining the signature from information associated with the mobile radio and information associated with the VoIP indication message; and
sending a VoIP indication message to the radio communications network that includes the signature.

18. The method in claim 17, further comprising:
determining the signature from data associated with subscriber identity module (SIM) data corresponding to the mobile radio.

19. The method in claim 17, wherein the signature is derivable from data associated with a frame number or a sequence number associated with the VoIP indication message.

20. The method in claim 17, wherein the radio communications network is an EDGE type network, and
wherein the VoIP indication message is sent by the mobile radio during a temporary block flow (TBF) set up procedure.

21. The method in claim 20, wherein the SIM data includes authentication triplets, and
wherein the signature is a one-way hash function that uses information derivable from authentication triplet data used during mobile station authentication and the frame or sequence number.

22. Apparatus for use in a mobile communications network, comprising electronic circuitry configured to perform the following after a mobile radio has been attached and authenticated by the radio communications network as a valid subscriber of the radio communications network:
receive a radio resource request associated with an application layer service and with the mobile radio, where the radio resource request is for a first level of radio access bearer service;
receive a secret identifier from the mobile radio in connection with the radio resource request;
determine whether the secret identifier is valid; and
if the secret identifier is valid, allocate the radio resources requested to permit the first level of radio access bearer service to be established for the associated application layer service.

23. The apparatus in claim 22, wherein the electronic circuitry is further configured to:
allocate radio resources to permit a second level of radio access bearer service to be established if the secret identifier is invalid,
wherein the first level is allocated more radio resources than the second level.

24. The apparatus in claim 23, wherein the electronic circuitry is further configured to:
determine if the subscriber is generally permitted to receive the first level of radio access bearer service, and
if not, authorize the subscriber to receive only the second level of radio access bearer service.

25. The apparatus in claim 23, wherein the application layer service is a Voice over IP (VoIP) service application.

26. The apparatus in claim 25, wherein the first level radio access bearer provides sufficient radio resources to support the VoIP service and the second level radio access bearer provides sufficient radio resources to support basic data packet transfer over the Internet.

27. The apparatus in claim 25, wherein the mobile radio is associated with a subscription with the mobile radio network that permits the first level of radio access bearer service, and
wherein the electronic circuitry is further configured to ensure that the mobile radio's VoIP service application uses a VoIP service provided by the mobile radio network with the first level of radio access bearer service and prevents the VoIP application from obtaining the first level of radio access bearer service for use with another VoIP service provided by an entity other than the mobile radio network.

28. The apparatus in claim 25, wherein the secret information is a signature derivable from information associated with the mobile radio and information associated with the VoIP indication message.

29. The apparatus in claim 28, wherein the signature is derivable from data associated with subscriber identity module (SIM) data corresponding to the mobile radio.

30. The apparatus in claim 28, wherein the signature is derivable from data associated with a frame number or a sequence number associated with the VoIP indication message.

31. The apparatus in claim 30, wherein the radio communications network is an EDGE type network, and the electronic circuitry is further configured to receive the VoIP indication message from the mobile radio during a temporary block flow (TBF) set up procedure.

32. The apparatus in claim 31, wherein the SIM data includes authentication triplets, and
wherein the signature is a one-way hash function that uses information derivable from authentication triplet data used during the mobile station authentication and the frame or sequence number.

33. The apparatus in claim 22 implemented in a network node.

34. The apparatus in claim 33, wherein the network node is a base station controller (BSC) node, a base station node, or a serving GPRS support node.

35. The apparatus in claim 22 implemented in a packet control unit.

36. Mobile radio apparatus for use in mobile radio for communicating with a mobile communications network, comprising electronic circuitry configured to:
attach to and authenticate with the radio communications network;
execute an application associated with an application layer service;
send a radio resource request the radio communications network for a first level of radio access bearer service to support the application layer service;
send to the radio communications network a secret identifier in connection with the radio resource request; and
receive a message from the radio communications network that the radio resources requested are allocated if the secret identifier is determined to be valid; and
continue execution of the application using the first level of radio access bearer service.

37. The apparatus in claim 36, wherein the electronic circuitry is further configured to:
receive a message from the radio communications network that the radio resources requested will not be allocated if the secret identifier is determined to be invalid; and
continue execution of the application using the second level of radio access bearer service.

38. The apparatus in claim 36, wherein the application layer service is a Voice over IP (VoIP) service application.

39. The apparatus in claim 38, wherein the first level radio access bearer provides sufficient radio resources to support the VoIP service and the second level radio access bearer provides sufficient radio resources to support basic data packet transfer over the Internet.

40. The apparatus in claim 38, wherein the secret identifier is a signature, and wherein the electronic circuitry is further configured to:
determine the signature from information associated with the mobile radio and information associated with the VoIP indication message; and
sending a VoIP indication message to the radio communications network that includes the signature.

41. The apparatus in claim 40, wherein the secret identifier is a signature, and wherein the electronic circuitry is further configured to:
determine the signature from data associated with subscriber identity module (SIM) data corresponding to the mobile radio.

42. The apparatus in claim 40, wherein the signature is derivable from data associated with a frame number or a sequence number associated with the VoIP indication message.

43. The apparatus in claim 40, wherein the radio communications network is an EDGE type network, and wherein the electronic circuitry is further configured to send the VoIP indication message during a temporary block flow (TBF) set up procedure.

44. The apparatus in claim 43, wherein the SIM data includes authentication triplets, and
wherein the signature is a one-way hash function that uses information derivable from authentication triplet data used during mobile station authentication and the frame or sequence number.
